(19) United States
(12) Patent Application Publication
(10) Pub. No.: US 2013/0268106 A1
(43) Pub. Date: Oct. 10, 2013

(54) REMOTE MONITORING SYSTEM FOR POLISHING END POINT DETECTION UNITS

(71) Applicant: EBARA CORPORATION, Tokyo (JP)

(72) Inventor: Ryuichiro MITANI, Tokyo (JP)

(21) Appl. No.: 13/777,035

(22) Filed: Feb. 26, 2013

(30) Foreign Application Priority Data
Feb. 29, 2012 (JP) 2012-043174

(51) Int. Cl. G05B 19/18

(52) U.S. Cl. CPC G05B 19/182
USPC 700/121

(57) ABSTRACT

The present invention relates to a remote monitoring system for polishing end point detection units mounted to polishing apparatuses for polishing wafers, such as substrates. The remote monitoring system includes: polishing end point detection units each configured to detect a polishing end point of a substrate; and a host computer coupled to the polishing end point detection units via a network. The host computer includes a memory configured to store polishing end point detection data sent from the polishing end point detection units and a display screen configured to display the polishing end point detection data. The host computer is configured to send a new polishing end point detection recipe to at least one polishing end point detection unit selected from the polishing end point detection units to rewrite a polishing end point detection recipe of the least one polishing end point detection unit.

### CROSS REFERENCE TO RELATED APPLICATIONS

This application claims priority to Japanese Patent Application No. 2012-43174 filed on Feb. 29, 2012, the entire contents of which are hereby incorporated by reference.

### BACKGROUND OF THE INVENTION

1. Field of the Invention

The present invention relates to a remote monitoring system for polishing end point detection units, and more particularly to a remote monitoring system for polishing end point detection units mounted to polishing apparatuses for polishing substrates, such as wafers.

2. Description of the Related Art

A polishing apparatus, which is typified by a CMP apparatus, is used in fabrication of semiconductor devices. Interconnect structures of the semiconductor devices are fabricated by forming a metal film (e.g., a copper film) on an insulating film having trenches formed along interconnect patterns and then removing unnecessary metal film with use of the polishing apparatus. This polishing apparatus is configured to move a substrate and a polishing pad relative to each other, while supplying a polishing liquid (i.e., slurry) onto the polishing pad on a polishing table, to thereby polish a surface of the substrate.

The polishing apparatus has a polishing end point detection unit for detecting a polishing end point of the substrate. This polishing end point detection unit is configured to monitor polishing of the substrate based on a polishing index value indicating a film thickness (e.g., a table torque current, an output signal of an eddy current film thickness sensor, an output signal of an optical film thickness sensor) and determine the polishing end point when the metal film is removed.

In a manufacturing plant of the semiconductor devices, a large number of (e.g., several tens of) polishing apparatuses are installed. Each one of these polishing apparatuses includes at least one polishing end point detection unit, and a plurality of polishing end point detection units are coupled to an operation center via a network. When a detection error of the polishing end point occurs in any one of the polishing end point detection units, an error signal is transmitted to the operation center. An operator can notice from the error signal occurrence of the detection error in the polishing end point detection unit. Once the detection error occurs, the operator moves over to that polishing end point detection unit, checks the state of the polishing end point detection unit, and, if necessary, modifies a polishing end point detection recipe (i.e., various settings for detecting the polishing end point).

However, the polishing apparatus is typically installed in a clean room, and it takes a certain time for the operator to move from the operation center to the clean room. Moreover, in order to enter the clean room, the operator should change into work clothes prepared for the clean room. When the detection errors occur in several polishing end point detection units, the operator needs to access every one of these polishing end point detection units so as to solve the detection errors. Further, in order to change the polishing end point detection recipes in all of the polishing end point detection units, the operator needs to access every one of these polishing end point detection units as well. In view of such circumstances, there has been a demand for monitoring and operating a large number of polishing end point detection units centrally at a single place.

### SUMMARY OF THE INVENTION

The present invention has been made in view of the above drawbacks. It is therefore an object of the present invention to provide a remote monitoring system capable of remote-monitoring and remote-controlling a plurality of polishing end point detection units.

One aspect of the present invention for achieving the above object is to provide a remote monitoring system includes: polishing end point detection units each configured to detect a polishing end point of a substrate; and a host computer coupled to the polishing end point detection units via a network. The host computer includes a memory configured to store polishing end point detection data sent from the polishing end point detection units and a display screen configured to display the polishing end point detection data. The host computer is configured to send a new polishing end point detection recipe to at least one polishing end point detection unit selected from the polishing end point detection units to rewrite a polishing end point detection recipe of the least one polishing end point detection unit.

In a preferred aspect of the present invention, the host computer is configured to display on the display screen an alarm in a manner to identify a polishing end point detection unit in which a polishing end point detection error has occurred.

In a preferred aspect of the present invention, the host computer includes a polishing end point detection recipe management tool configured to create and change the new polishing end point detection recipe.

In a preferred aspect of the present invention, each of the polishing end point detection units includes a polishing end point detection recipe management tool configured to create and change the polishing end point detection recipe.

In a preferred aspect of the present invention, the polishing end point detection data includes a polishing index value indicating a film thickness of the substrate, and the host computer is configured to perform simulation of a polishing end point detection of a substrate with use of a preset replay recipe and the polishing index value.

In a preferred aspect of the present invention, each of the polishing end point detection units is configured to send a new polishing end point detection recipe to at least one polishing end point detection unit selected from the polishing end point detection units to rewrite a polishing end point detection recipe of the least one polishing end point detection unit.

In a preferred aspect of the present invention, each of the polishing end point detection units has a display screen configured to display an end point detection window showing the polishing end point detection data.

In a preferred aspect of the present invention, the host computer is configured to display an end point detection window which is the same as the end point detection window displayed on each polishing end point detection unit.

In a preferred aspect of the present invention, the host computer is configured to be able to change a structure of the end point detection window on the display screen of the host computer.

In a preferred aspect of the present invention, each of the polishing end point detection units is configured to be able to display on its own display screen an end point detection window which is the same as the end point detection window displayed on other polishing end point detection unit.

In a preferred aspect of the present invention, each of the polishing end point detection units is configured to be able to change a structure of the end point detection window of the other polishing end point detection unit displayed on its own display screen.

In a preferred aspect of the present invention, the host computer is capable of remotely controlling the polishing end point detection units.

In a preferred aspect of the present invention, each of the polishing end point detection units is capable of remotely controlling other polishing end point detection unit.

According to the present invention, an operator (a worker) can inspect a cause of the polishing end point detection error from the host computer installed in an operation center or the like and can correct the detection recipe to solve the detection error, without moving over to the polishing end point detection unit in which the polishing end point detection error has occurred.

### BRIEF DESCRIPTION OF THE DRAWINGS

FIG. 1 is a view of an embodiment of a remote monitoring system for polishing end point detection units according to the present invention;

FIG. 2 is a view of a polishing apparatus (CMP apparatus);

FIG. 3 is a view of a monitoring window displayed on a display screen of a host computer;

FIG. 4 is a view showing an end point detection window displayed on a display screen of a polishing end point detection unit;

FIG. 5 is a view showing a graph window;

FIG. 6 is view showing a polishing end point detection recipe management tool;

FIG. 7 is a view showing a tree structure displayed in the polishing end point detection recipe management tool; and

FIG. 8 is a view showing a replay window.

### DETAILED DESCRIPTION OF THE PREFERRED EMBODIMENTS

Embodiments of the present invention will be described below with reference to the drawings.

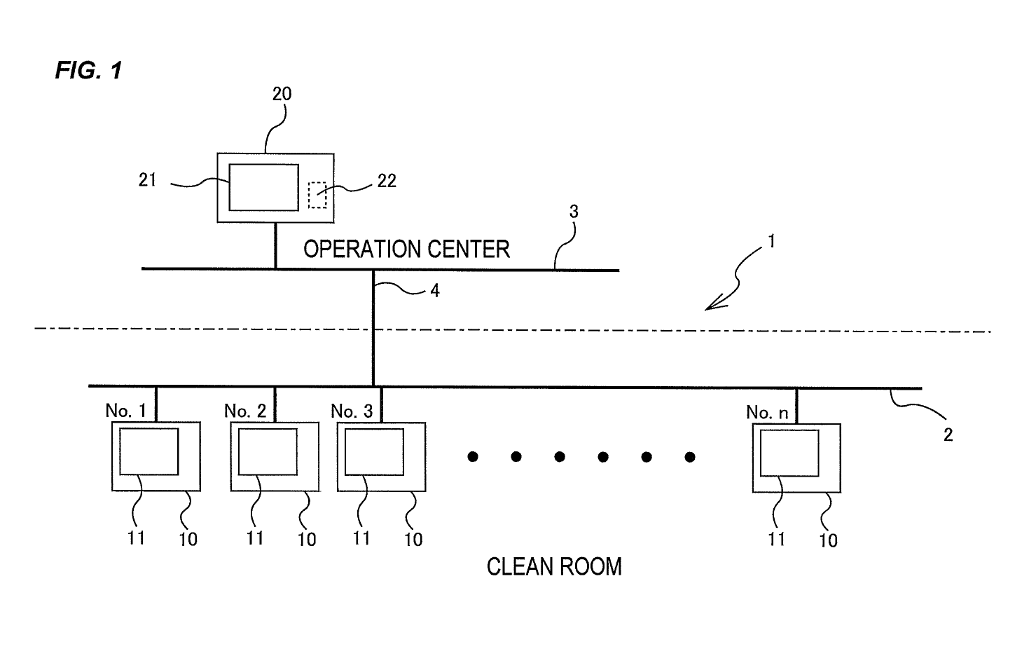

FIG. 1 is a view of an embodiment of a remote monitoring system of polishing end point detection units according to the present invention. As shown in FIG. 1, this remote monitoring system includes a plurality of polishing end point detection units 10 provided respectively in a plurality of polishing apparatuses, and a host computer 20 coupled to these polishing end point detection units 10 via a network 1. The host computer 20 and all of the polishing end point detection units 10 are able to access mutually through the network 1.

The polishing end point detection units 10 are typically installed in a clean room of a semiconductor device manufacturing plant. A CR network 2 is constructed in the clean room and each of the polishing end point detection units 10 is coupled to the CR network 2. The host computer 20 is installed in an operation center which is located away from the clean room. An OC network 3 is constructed in the operation center, and the host computer 20 is coupled to the OC network 3. The CR network 2 and the OC network 3 are coupled to each other via the Internet 4. While the CR network 2 and the OC network 3 are separated in this embodiment, these networks may be combined into a single network.

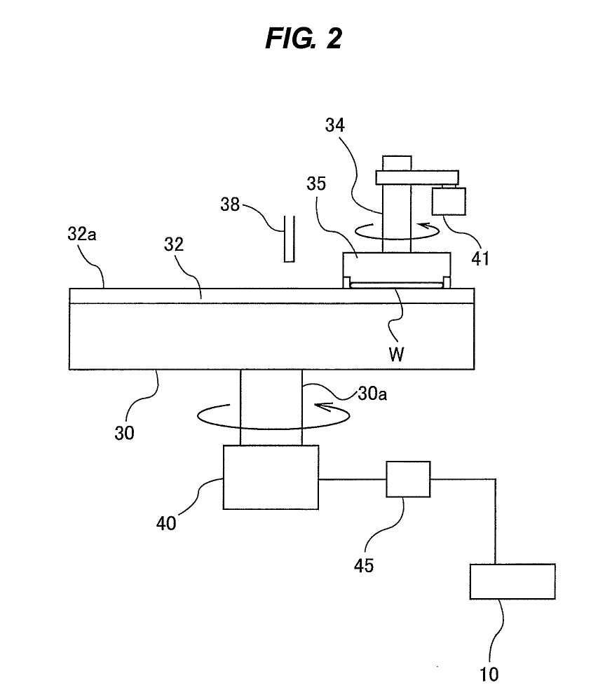

FIG. 2 is a view of a polishing apparatus in which the polishing end point detection unit 10 is incorporated. This polishing apparatus is a CMP apparatus for chemically mechanically polishing a substrate. As shown in FIG. 2, the polishing apparatus has a polishing table 30, a top ring 35 coupled to a lower end of a top ring shaft 34, and the polishing end point detection unit 10 for detecting a polishing end point. The top ring shaft 34 is coupled to a top ring rotating motor 41 through a coupling device, such as a timing belt, so that the top ring shaft 34 is rotated by the top ring rotating motor 41. This rotation of the top ring shaft 34 in turn rotates the top ring 35 about the top ring shaft 34 as indicated by arrow. A substrate (e.g., a wafer) W is held on a lower surface of the top ring 35 by vacuum suction.

The polishing table 30 is coupled to a table rotating motor 40 through a table shaft 30a, so that the polishing table 30 is rotated about the table shaft 30a by the table rotating motor 40 as illustrated by arrow. The table rotating motor 40 is located below the polishing table 30. A polishing pad 32 is attached to an upper surface of the polishing table 30. This polishing pad 32 has an upper surface 32a which provides a polishing surface for polishing the substrate W. A polishing liquid supply mechanism 38 for supplying a polishing liquid (slurry) onto the polishing surface 32a is arranged above the polishing table 30.

Polishing of the substrate W is performed as follows. The top ring 35 and the polishing table 30 are rotated by the motors 41 and 40, respectively, while the polishing liquid is supplied onto the polishing surface 32a of the polishing pad 32 from the polishing liquid supply mechanism 38. In this state, the top ring 35 presses the substrate W against the polishing surface 32a. The substrate W is polishing by a mechanical action due to a sliding contact with the polishing pad 32 and a chemical action due to the polishing liquid.

A table motor current detector 45 for measuring a motor current is coupled to the table rotating motor 40. Further, the table motor current detector 45 is coupled to the polishing end point detection unit 10. During polishing of the substrate W, the surface of the substrate W is placed in sliding contact with the polishing surface 32a of the polishing pad 32. As a result, a frictional force is generated between the substrate W and the polishing pad 32. This frictional force acts as a resistance torque on the table rotating motor 40. The polishing end point detection unit 10 is configured to detect a polishing end point of the substrate W based on the motor current (i.e., torque current) measured by the table motor current detector 45.

A substrate having a multilayer structure includes different kinds of films formed thereon. When an uppermost film is removed by polishing of the substrate, an underlying film appears on a surface of the substrate. Generally, these films have different hardness. Therefore, when the upper film is removed and as a result the lower film is exposed, the frictional force between the substrate W and the polishing pad 32 changes. This change in the frictional force can be detected as a change in the resistance torque that is applied to the table rotating motor 40. The polishing end point detection unit 10 detects removal of the film, i.e., the polishing end point, based on the change in the current to the table rotating motor 40. In another embodiment, instead of providing the current detector 45, the polishing end point detection unit 10 may monitor the current outputted from a motor driver (not shown) that is coupled to the motor 40.

While the polishing end point detection unit 10 shown in FIG. 2 is configured to detect the polishing end point based on the torque current for rotating the polishing table 30, the present invention is not limited to this embodiment. For example, the polishing end point detection unit 10 may detect the polishing end point of the substrate with use of a film thickness sensor for detecting a film thickness of the substrate (e.g., an eddy current sensor or an optical sensor). A known technique for detecting the polishing end point of the substrate with use of such a film thickness sensor, as disclosed in Japanese laid-open patent publication No. 2005-203729, may be used.

Referring back to FIG. 1, the polishing end point detection units 10 are coupled to each other via the CR network 2, so that the polishing end point detection units 10 can share polishing end point detection data (including substrate polishing information) stored in each of the polishing end point detection units 10. Each polishing end point detection unit 10 has a display screen 11 on which the above-mentioned polishing end point detection data can be displayed during polishing of the substrate. The polishing end point detection data are shared with all of the polishing end point detection units 10 installed in the clean room, so that each polishing end point detection unit 10 can not only display the polishing end point detection data of its own, but can also display the polishing end point detection data of other polishing end point detection units 10.

Further, the polishing end point detection data of the respective polishing end point detection units 10 are transmitted to the host computer 20 through the network 1 (which is constituted by the CR network 2, the OC network 3, and the Internet 4), and operation states of all of the polishing end point detection units 10 are monitored by the host computer 20. This host computer 20 has a display screen 21 on which the same polishing end point detection data as those of the polishing end point detection units 10 can be displayed during polishing of the substrates. The polishing end point detection data that are sent from the respective polishing end point detection units 10 are stored in a memory 22 (e.g., a hard disk) of the host computer 20.

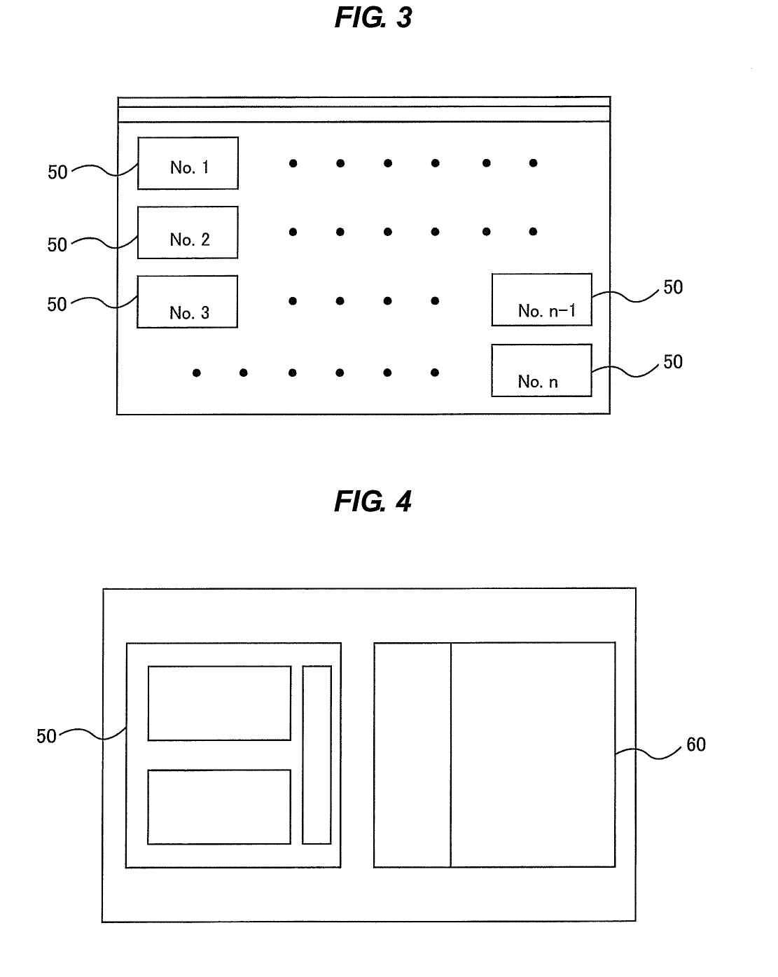

FIG. 3 is a view of a monitoring window displayed on the display screen 21 of the host computer 20. As shown in FIG. 3, graph windows 50 related respectively to all of the polishing end point detection units 10 (No. 1 to No. n) are displayed on the monitoring window. Each graph window 50 displays a graph indicating a change with time in the table torque current (i.e., the motor current required for rotating the polishing table 30 at a preset rotational speed) obtained by each polishing end point detection unit 10.

When a polishing end point detection error occurs in any one of the polishing end point detection units 10, an alarm is displayed on the monitoring window in a manner to identify the polishing end point detection unit 10 in which the detection error has occurred. More specifically, the graph window 50 of the polishing end point detection unit 10 in which the detection error has occurred blinks. Therefore, the operator can realize, through the display screen 21 of the host computer 20, in which of the polishing end point detection units 10 the detection error of the polishing end point has occurred. Examples of such polishing end point detection error include a failure of detecting the polishing end point within a preset time and a detection of the polishing end point prior to a preset time.

The manner of giving the alarm about the polishing end point detection error is not limited to the above example in which the graph window 50 blinks. For example, the graph window 50 of the polishing end point detection unit 10 in which the detection error has occurred may be displayed in a different color or may be enlarged (in a pop-up manner) with a massage indicating the occurrence of the detection error. The monitoring window shown in FIG. 3 can also be displayed on the display screen 11 of each of the polishing end point detection units 10.

FIG. 4 is a view showing an end point detection window displayed on the display screen 11 of the polishing end point detection unit 10. This end point detection window includes: the above-described graph window 50 showing the change with time in the table toque current; and a polishing end point detection recipe management tool 60 that displays several kinds of setting items for detecting the polishing end point.

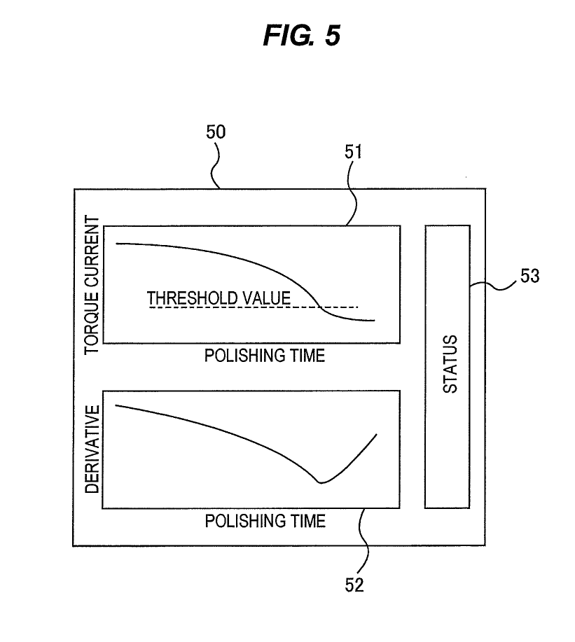

FIG. 5 is a view of the graph window 50 shown in FIG. 4. As shown in FIG. 5, the graph window 50 is configured to display an effective value graph 51 showing the table torque current that varies with a polishing time, a derivative graph 52 showing a derivative of the table torque current (an effective value), and a status area 53 showing information of the substrate that is currently being polished. The status area 53 includes several items, such as a lot number of the substrate and a substrate number.

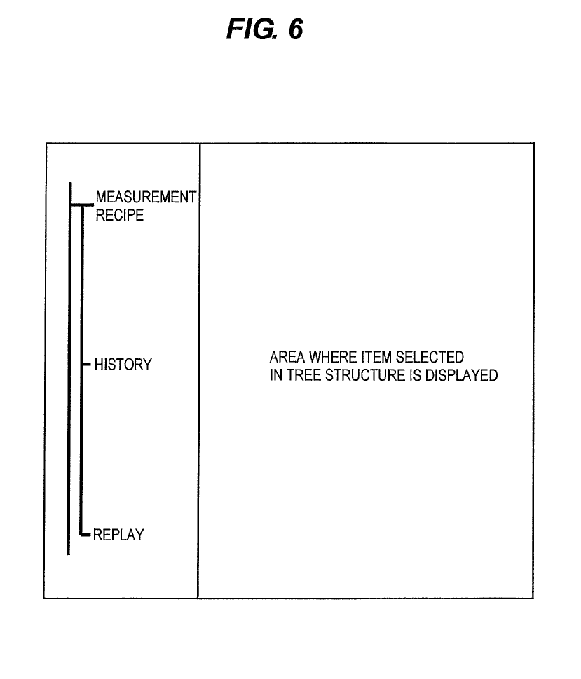

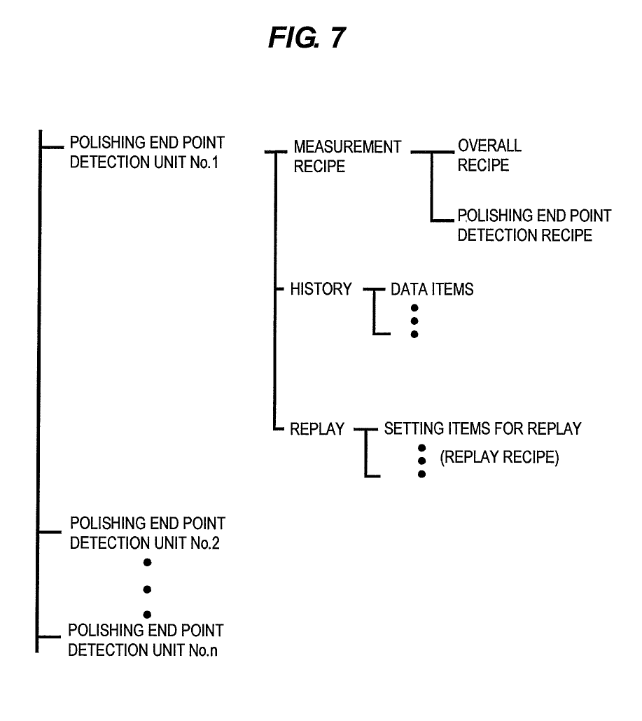

FIG. 6 is view showing the polishing end point detection recipe management tool 60 shown in FIG. 4. As shown in FIG. 6, a left-side area of the polishing end point detection recipe management tool 60 is an area where a tree structure is displayed, and a right-side area is an area where details of an item selected in the tree structure are displayed. FIG. 7 is a view showing the tree structure displayed in the polishing end point detection recipe management tool 60. An uppermost layer of the tree structure is a layer for selecting (or specifying) the polishing end point detection unit 10, and a layer underneath the uppermost layer is a layer for selecting either one of a measurement recipe, history, and a replay.

The measurement recipe is constituted by an overall recipe for determining a method of polishing the substrate, and a polishing end point detection recipe for detecting the polishing end point of the substrate. The overall recipe includes several setting items, such as a rotational speed of the polishing table and an over-polishing time after the detection of the polishing end point. The polishing end point detection is conducted according to the polishing end point detection recipe. More specifically, a point of time when the table torque current or the derivative thereof reaches a predetermined threshold value is determined to be the polishing end point. A plurality of threshold values may be provided. In this case, the polishing end point may be determined on a condition that the table torque current or the derivative thereof reaches all of the threshold values.

The setting items of the polishing end point detection recipe include the threshold value of the table torque current, the number of threshold values of the table torque current, the threshold value of the derivative of the table torque current, and the number of threshold values of the derivative of the table torque current. Creation, update (or modification), and deletion of the overall recipe and the polishing end point detection recipe are executed with use of the polishing end point detection recipe management tool 60.

The polishing end point detection data with respect to substrates that have been polished in the past are displayed in the history. The polishing end point detection data are stored in a memory (not shown) of each polishing end point detection unit 10 and in the memory 22 of the host computer 20. The polishing end point detection data are constructed by various kinds of data items including the table toque current value (a film thickness index value) and the derivative thereof obtained during polishing of each substrate, the setting items for the polishing end point detection (e.g., the threshold value of the table torque current), time and date when the substrate was polished, a polishing time, a log of the detection error, and a log of communication with an operation controller of the polishing apparatus. Therefore, it is possible to comprehend, from the history, how the polishing end point detection of the substrate was performed in the past.

The replay is used when replaying or simulating the polishing end point detection with use of the stored polishing end point detection data. Setting items of the replay include a polishing end point detection recipe for the replay (which will be hereinafter referred to as replay recipe). By applying this replay recipe to the polishing end point detection data (e.g., the table torque current value and/or the derivative thereof), the simulation of the polishing end point detection can be conducted. For example, it is possible to estimate the polishing end point detection result that could vary in accordance with the change in the threshold value of the table torque current value and/or the derivative thereof.

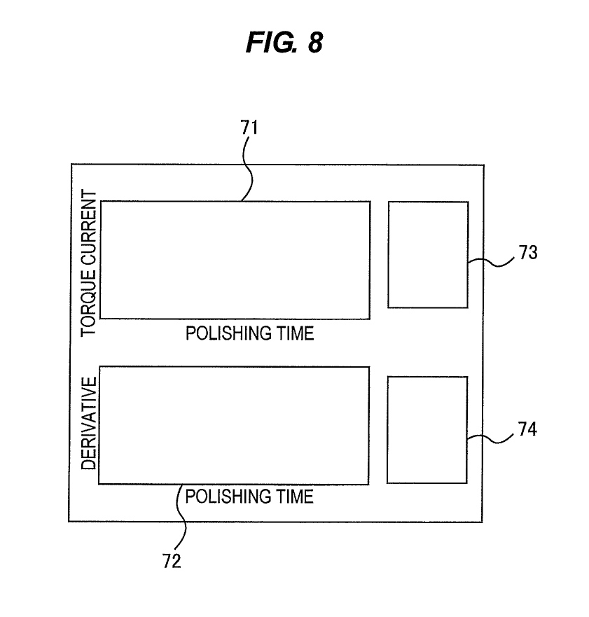

The simulation result of the polishing end point detection with use of the replay recipe is displayed on a replay (simulation) window. FIG. 8 is a view of the replay window. As shown in FIG. 8, the replay window is constructed by an effective value graph 71 showing the table torque current value that varies with the polishing time, a derivative graph 72 showing the derivative of the table torque current value, a replay recipe area 73 showing information about the substrate subject to the simulation and various kinds of setting items of the replay recipe, and a result display area 74 showing a list of simulation results of the polishing end point detection.

The host computer 20 is configured to be able to access each of the polishing end point detection units 10 installed in the clean room and remotely control the polishing end point detection units 10. Further, the host computer 20 is able to display on its display screen 21 the end point detection window (see FIG. 4) of each of the polishing end point detection units 10. Specifically, when one of the graph windows 50 on the monitoring window shown in FIG. 3 is clicked, the host computer 20 accesses the polishing end point detection unit 10 corresponding to the clicked graph window 50 and displays the end point detection window of that unit 10 on the display screen 21. For example, by clicking the blinking graph window 50, more detailed information about the polishing end point detection unit 10 in which the detection error has occurred can be displayed on the display screen 21.

The host computer 20 is able to display on its display screen 21 an end point detection window which has the same structure as that of the end point detection window displayed on each polishing end point detection unit 10. Specifically, the end point detection window displayed on the display screen 21 of the host computer 20 is exactly the same in its structure (i.e., the number and arrangement of small windows) as the end point detection window displayed on the display screen 11 of the selected polishing end point detection unit 10. Further, the host computer 20 is configured to be able to change the structure of the end point detection window to be displayed on its display screen 21, as desired.

Similarly, each of the polishing end point detection units 10 is able to display on its own display screen 11 the end point detection window that is exactly the same as the end point detection window displayed on the other polishing end point detection unit 10. Further, each of the polishing end point detection units 10 is configured to be able to change the structure of the end point detection window of the other unit 10 to be displayed on its own display screen 11, as desired.

The host computer 20 has a polishing end point detection recipe management tool 60 which is the same as that of the polishing end point detection units 10, so that the host computer 20 can perform the simulation of the polishing end point detection using the polishing end point detection data stored in the polishing end point detection units 10.

The host computer 20 is further configured to be able to change the polishing end point detection recipes of the polishing end point detection units 10 through the polishing end point detection recipe management tool 60 displayed on the display screen 21. For example, when the polishing end point detection error has occurred in one of the polishing end point detection units 10, the host computer 20 can correct the detection error by changing the polishing end point detection recipe that is set in that polishing end point detection unit 10. Therefore, it is not necessary for the operator to move over to the clean room. As a result, the operator can correct the detection error within a short period of time.

Further, the host computer 20 is able to access some or all of the polishing end point detection units 10 so as to change the polishing end point detection recipes set in those polishing end point detection units 10 at the same time. Therefore, it is not necessary to access each one of the polishing end point detection units 10 in order to modify the polishing end point detection recipes one by one. As a result, it is possible to update or rewrite the polishing end point detection recipes within a very short period of time.

The above-described display operation and the recipe operation can be performed by each of the polishing end point detection units 10. Specifically, any one of the polishing end point detection units 10 can display the end point detection window (i.e., the graph window 50 and the polishing end point detection recipe management tool 60) of the other polishing end point detection 10. Moreover, any one of the polishing end point detection units 10 can change the polishing end point detection recipe of the other polishing end point detection units 10. In addition, any one of the polishing end point detection units 10 can remotely control the other polishing end point detection units 10.

The host computer 20 and all of the polishing end point detection units 10 share the polishing end point detection data that are stored respectively in the polishing end point detection units 10, and can display these data on their own screens. According to the above-discussed embodiment of the remote monitoring system, it is possible to obtain polishing information from the plurality of the polishing end point detection units 10 installed in the clean room and remotely control these polishing end point detection units 10.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims.

What is claimed is:

1. A remote monitoring system, comprising:
a plurality of polishing end point detection units each configured to detect a polishing end point of a substrate; and
a host computer coupled to the polishing end point detection units via a network, the host computer including a memory configured to store polishing end point detection data sent from the polishing end point detection units and a display screen configured to display the polishing end point detection data,
wherein the host computer is configured to send a new polishing end point detection recipe to at least one polishing end point detection unit selected from the polishing end point detection units to rewrite a polishing end point detection recipe of the least one polishing end point detection unit.

2. The remote monitoring system according to claim 1, wherein the host computer is configured to display on the display screen an alarm in a manner to identify a polishing end point detection unit in which a polishing end point detection error has occurred.

3. The remote monitoring system according to claim 1, wherein the host computer includes a polishing end point detection recipe management tool configured to create and change the new polishing end point detection recipe.

4. The remote monitoring system according to claim 3, wherein each of the polishing end point detection units includes a polishing end point detection recipe management tool configured to create and change the polishing end point detection recipe.

5. The remote monitoring system according to claim 1, wherein the polishing end point detection data includes a polishing index value indicating a film thickness of the substrate, and
wherein the host computer is configured to perform simulation of a polishing end point detection of a substrate with use of a preset replay recipe and the polishing index value.

6. The remote monitoring system according to claim 1, wherein each of the polishing end point detection units is configured to send a new polishing end point detection recipe to at least one polishing end point detection unit selected from the polishing end point detection units to rewrite a polishing end point detection recipe of the least one polishing end point detection unit.

7. The remote monitoring system according to claim 1, wherein each of the polishing end point detection units has a display screen configured to display an end point detection window showing the polishing end point detection data.

8. The remote monitoring system according to claim 7, wherein the host computer is configured to display an end point detection window which is the same as the end point detection window displayed on each polishing end point detection unit.

9. The remote monitoring system according to claim 8, wherein the host computer is configured to be able to change a structure of the end point detection window on the display screen of the host computer.

10. The remote monitoring system according to claim 7, wherein each of the polishing end point detection units is configured to be able to display on its own display screen an end point detection window which is the same as the end point detection window displayed on other polishing end point detection unit.

11. The remote monitoring system according to claim 10, wherein each of the polishing end point detection units is configured to be able to change a structure of the end point detection window of the other polishing end point detection unit displayed on its own display screen.

12. The remote monitoring system according to claim 1, wherein the host computer is capable of remotely controlling the polishing end point detection units.

13. The remote monitoring system according to claim 1, wherein each of the polishing end point detection units is capable of remotely controlling other polishing end point detection unit.
